(19) United States
(12) Patent Application Publication
(10) Pub. No.: US 2020/0399000 A1
(43) Pub. Date: Dec. 24, 2020

(54) AIRCRAFT REFUELLING DEVICE, COMMISSIONING METHOD, AND REFUELLING METHOD USING SUCH A DEVICE

(71) Applicant: DESAUTEL, Lyon (FR)

(72) Inventor: Claude Beck, Bordeaux (FR)

(21) Appl. No.: 16/978,680

(22) PCT Filed: Mar. 5, 2019
(86) PCT No.: PCT/EP2019/055403

§ 371 Date: Sep. 5, 2020

(30) Foreign Application Priority Data
Mar. 6, 2018 (FR) 1851925

(51) Int. Cl. B64F 1/28; B67D 7/08

(52) U.S. Cl. CPC B64F 1/28; B67D 7/08

(57) ABSTRACT

Aircraft refueling device including a deformable pipe for the circulation of fuel, the downstream end of which is provided with a wing fastener for the connection thereof onto an intake port of the aircraft fuel tank. The device includes a first sensor for measuring the pressure values, in the vicinity of the wing fastener, of a fuel flow in the deformable pipe, and means for determining the flow rate in the deformable pipe. The device further includes a second sensor for measuring the pressure values of the flow upstream of the deformable pipe, a unit for calculating the pressure drop of the flow in the deformable pipe, based on the pressure values measure by the first and second sensors. The device also includes a unit for comparing the calculated pressure drop value with a reference value, established during the commissioning phase, for example, for the same flow rate.

### CROSS-REFERENCE TO RELATED APPLICATIONS

This application claims benefit under 35 USC § 371 of PCT Application No. PCT/EP2019/055403 entitled AIRCRAFT REFUELING DEVICE, COMMISSIONING METHOD, AND REFUELING METHOD USING SUCH A DEVICE, filed on Mar. 5, 2019 by inventor Claude Beck. PCT Application No. PCT/EP2019/055403 claims priority of French Patent Application No. 18 51925, filed on Mar. 6, 2018.

### FIELD OF THE INVENTION

The present invention relates to a device for refueling an aircraft, as well as a method for commissioning such a device and a method for refueling an aircraft using such a device.

### BACKGROUND OF THE INVENTION

In civilian and military airports and aerodromes, it is known to use refueling vehicles that are moved close to aircraft in order to fill their tanks with fuel.

Thus, WO-A-2010/128246 discloses a refueling vehicle whereof the wing fastener is equipped with a sensor making it possible to determine the value of the pressure of a flow of fuel passing through this wing fastener. This device is satisfactory.

Such a refueling vehicle, of the hydrant servicer type, includes rigid piping portions that are stationary relative to its rolling chassis, as well as a deformable pipe, which makes it possible to adjust the position of the wing fastener based on the position of an inlet port of a tank of the aircraft. Such a deformable pipe can be made by flexible tubing, in particular made from elastomer, or by a series of rigid tubing portions connected to one another by rotary joints.

The situation is comparable for a bowser, which, unlike a hydrant servicer, bears a fuel tank on its chassis.

In these known equipment items, a mechanical pressure regulator is arranged downstream of the deformable pipe, so as to limit the pressure from the flow of fuel that passes through the wing fastener and which is poured into the tank of the aircraft. Such a mechanical pressure regulator, which is generally attached to the wing fastener, is a relatively heavy and complex equipment item, which requires elaborate maintenance operations. Furthermore, the mechanical pressure regulator is in practice adjusted to limit the pressure of the flow penetrating the tank of the aircraft to a value close to 3.5 bars. If the pressure of the flow is inclusively between 3 and 3.5 bars, the mechanical regular is active and generates a variable pressure drop, which limits this pressure. If the pressure of this flow is less than 3 bars, the mechanical regulator is completely open.

### SUMMARY OF THE DESCRIPTION

The invention more particularly aims to resolve these drawbacks by proposing a new device for refueling an aircraft that is lighter, simpler, more reliable and more cost-effective to implement than those of the state of the art.

To that end, the invention relates to an aircraft refueling device, this device comprising a deformable pipe for the circulation of fuel, the downstream end of which is provided with a wing fastener for the connection thereof onto an intake port of the aircraft fuel tank. This refueling device comprises a first sensor for measuring the pressure values, in the vicinity of the wing fastener, of a fuel flow in the deformable pipe, and means for determining the flow rate in the deformable pipe. According to the invention, the refueling device further comprises a second sensor for measuring the pressure values of the flow upstream of the deformable pipe. Additionally, a unit is provided for calculating the value of the pressure drop of the flow in the deformable pipe, based on the pressure values measured by the first and second sensors, as well as a unit for comparing this calculated pressure drop value with a reference value established for the same flow rate.

Owing to the invention, the first and second sensors allow a continuous monitoring of the pressure drop that has actually taken place in the deformable pipe and, by comparing it to the reference value, make it possible to react if the calculated pressure drop drifts. Indeed, it is possible to consider that, during normal operation of the refueling device, this pressure drop varies little in the absence of anomalies or modifications of the fuel flow circuit in the refueling device. Thus, a drift of the calculated pressure drop value, that is to say a significant variation of this value relative to the reference value, can be considered to correspond to an abnormal situation, such as clogging of the sieve of an inlet strainer of the wing fastener or a configuration of the deformable pipe resulting in a localized restriction of its section. Continuously monitoring the pressure drop therefore makes it possible to react to an abnormal situation, including outside the active operating range of a mechanical pressure regulator.

According to advantageous, but optional aspects of the invention, such a device may incorporate one or more of the following features, considered according to any technically allowable combination:
The refueling device comprises a pressure regulator installed on the path of the flow, upstream of the deformable pipe, and a control loop of this pressure regulator comprising the first sensor for measuring values of the pressure of the flow and the calculating and comparison unit(s).
The refueling device has no mechanical pressure regulator arranged, on the flow path, at the outlet of or downstream of the deformable pipe.
The refueling device also comprises means for calculating a value of the pressure, in the vicinity of the wing fastener, of the fuel flow in the deformable pipe, based on the pressure of the flow upstream of the deformable pipe and the reference value established for the same flow rate.

According to another aspect, the invention relates to a method for commissioning a refueling device as mentioned above, this method comprising at least the following steps:
a) establishing a relationship between the fuel flow rate in the deformable pipe and the pressure drop in the deformable pipe, in the normal operating condition of the refueling device;
b) storing, for different flow rates, a reference value of the pressure drop in the deformable pipe.

Owing to the inventive method, it is possible, upon commissioning of the refueling device, to determine the normal or acceptable head loss in the deformable pipe, which makes it possible to consider this pressure drop to be a reference value and to react appropriately when the pressure drop actually measured during the subsequent use of the refueling device deviates significantly from the reference value. Within the meaning of the present invention, a commissioning of a refueling device can be done before the first use of the device, when the latter is new, or after a maintenance operation affecting the deformable pipe or the associated measuring means.

According to still another aspect, the invention relates to a refueling method for an aircraft using a refueling device as mentioned above, commissioned through the aforementioned method. This method comprises at least the following steps:
c) measuring a first value of the pressure of the fuel flow in the deformable pipe in the vicinity of the wing fastener, using the first sensor;
d) determining the flow rate in the deformable pipe;
e) measuring a second value of the pressure upstream of the deformable pipe, using the second sensor;
f) calculating the value of the pressure drop in the deformable pipe, by subtracting the value measured in step c) from the value measured in step
e); and
g) comparing the value calculated in step f) to the reference value stored in step b) for the same rate as that determined in step d).

This method according to the invention takes advantage of the fact that the two sensors make it possible to measure pressure values usable to calculate the actual pressure drop in the deformable pipe. The comparison of this calculated pressure drop to the reference value, which corresponds to a normal operation of the refueling device, makes it possible to ensure that the refueling device is used in a configuration close to its normal operating configuration and to detect when this is not the case.

Advantageously, the aforementioned method comprises at least one additional step consisting, based on the result of the comparison step g) and a preestablished tolerance margin, of indicating that the refueling is taking place normally or abnormally.

In the case where the pressure values measured by the first sensor are transmitted to a control unit of the refueling device, it is possible to provide that, in case of temporary interruption of the transmission of the values measured by the first pressure sensor, this method comprises at least steps consisting of:
i) accessing the reference value of the pressure drop stored in step b) for the same rate as that determined in step d);
j) calculating a substitution value for the value measured by the first pressure sensor by subtracting the reference value accessed in step i) from the second value measured in step e); and
k) using the substitution value calculated in step j), in place of the value measured by the first sensor, to monitor the refueling in progress, without interrupting the refueling.

This method makes it possible to address a particular problem related to the latency of the transmission of a signal representative of the value measured by the first sensor, in particular when this transmission takes place wirelessly. Indeed, such a wireless transmission is often preferable in this case, due to the deformable nature of the pipe. Such a wireless transmission can be disrupted or delayed by external causes. By hypothesizing that the pressure drop is stable, that is to say more or less constant, over a usage period of the refueling device, this inventive method makes it possible to temporarily compensate for a transmission defect of the signal representative of the value measured by the first sensor by reconstituting the substitution value, which avoids interrupting the refueling in progress.

Advantageously, this method comprises an additional step consisting, in case of implementation of steps j) and k), of indicating that the refueling is taking place in a temporarily downgraded mode.

It is further possible to provide that steps d), e), i), j) and k) are implemented by iteration in a time interval with a predetermined maximum duration and that, in case of persistence of the temporary interruption of the transmission of value measured by the first sensor beyond this predetermined maximum duration, an alarm signal is emitted.

### BRIEF DESCRIPTION OF THE DRAWINGS

The invention will be better understood and other advantages thereof will appear more clearly in light of the following description of a refueling device according to the invention, its commissioning method and an associated refueling method, provided solely as an example and done in reference to the appended drawings, in which:

FIG. 1 is a schematic block diagram of a refueling vehicle including a refueling device according to the invention, during use to fill the tank of an aircraft with fuel;

FIG. 2 is an elevation view of a wing fastener and part of a fuel circulation pipe belonging to the refueling device shown in FIG. 1;

FIG. 3 is a schematic illustration of a curve of reference values of a pressure drop used in the refueling method of the invention;

FIG. 4 is a block diagram of a commissioning method according to the invention; and

FIG. 5 is a block diagram of a refueling method according to the invention.

### DETAILED DESCRIPTION

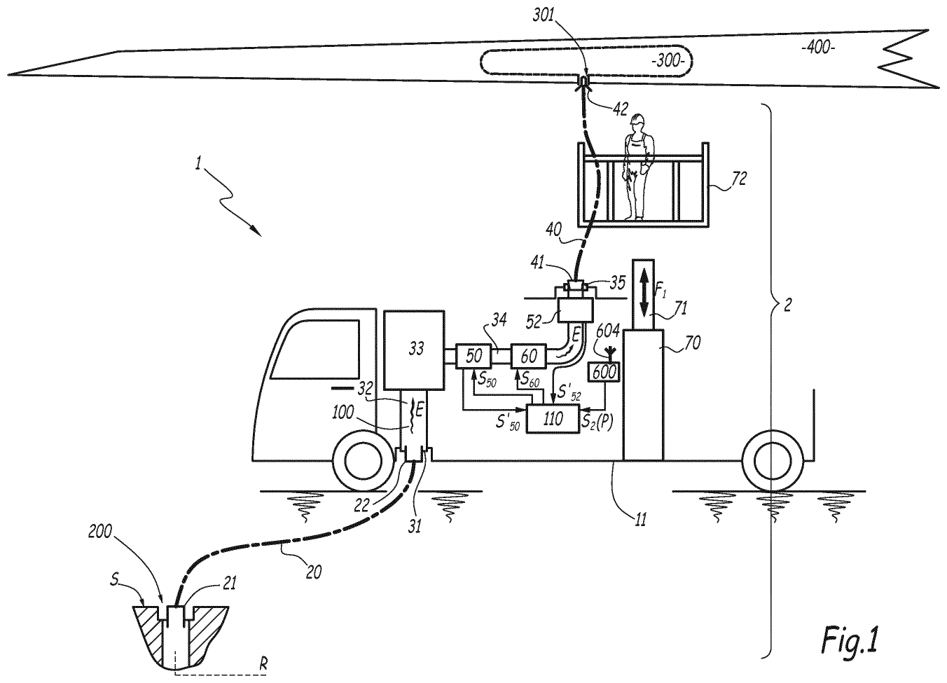

The refueling vehicle or hydrant servicer 1 shown in FIG. 1 generally assumes the form of an industrial vehicle equipped with a deformable tubing 20, in the case at hand a flexible tubing, allowing it to be connected on an outlet mouth 200 belonging to a fixed fuel distribution network R in an airport. The mouth 200 is arranged below the surface S of the ground, near a parking location of an aircraft 400. The tubing 20 is equipped with a connector 21 for connecting on the mouth 200. At its end opposite the connector 21, the tubing 20 is equipped with another connector 22 for connecting on a connector 31 making up the mouth of a fixed pipe 32 of the vehicle 1. In other words, the tubing 20 makes it possible to connect the outlet mouth 200, which belongs to the fixed network R, to the pipe 32, which belongs to the vehicle 1.

The pipe 32 emerges in a filter 33 provided to rid the fuel of residues, in particular aqueous, that it may contain.

Downstream of the filter 33, a pipe 34 extends to a connector 35 on which is connected an upstream connector 41 of a second deformable tubing 40, in the case at hand a flexible tubing. A wing fastener 42 is connected on the downstream end 43 of the second deformable tubing 40 and constitutes a means for connecting the tubing 40 on an inlet port 301 of a tank 300 integrated into the wing 400 of an airplane.

According to one optional aspect of the invention that is not shown for the clarity of the drawing, but which is typical in practice, a lining of the second flexible tubing 40 and the wing fastener 42 can be considered.

For the clarity of the drawings, the flexible tubings 20 and 40 are shown, in FIG. 1, by axis lines corresponding to their respective longitudinal axes.

The parts 20 to 42 belong to a refueling device 2 that is part of the vehicle 1.

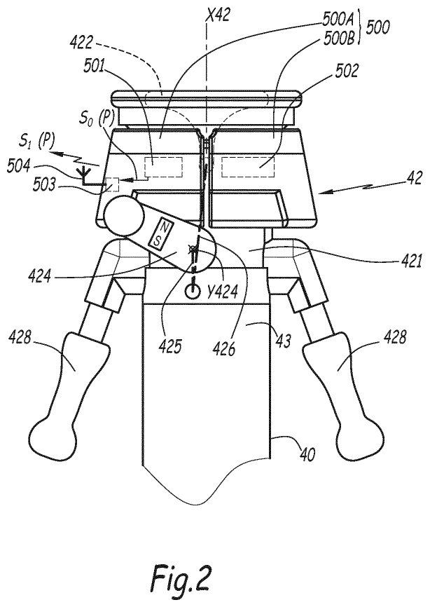

The wing fastener 42 comprises a cylindrical body 421 equipped with a ring, not shown and known in itself, preferably with international profile ISO45 allowing it to be locked by shape cooperation on a corresponding connector, also not shown and known in itself, delimiting the port 301. The wing fastener 42 is also provided with a so-called front valve 422, which is translatable along the longitudinal axis X42 of the wing fastener 42, between a first closed position shown in FIG. 2, where this front valve 422 bears against a seat, not shown, formed by the body 421, and a second open position, not shown, where the front valve 422 is separated from the seat.

In its first closed position, the front valve 422 prevents the flow of fuel from the flexible tubing 40 toward the tank 300. In its second open position, the front valve 422 allows such a flow.

The maneuvering of the front valve 422 between its first and second positions is done using a lever 424 that is mounted pivoting on the body 421 about an axis Y424 perpendicular to the longitudinal axis X42. The lever 424 is movable about the axis Y424 between the two extreme positions. A set of articulated connecting rods 425 and 426, shown very schematically, transparently, in FIG. 2, connects the lever 424 to the valve 422 and converts the rotational movement of the lever 424, about the axis Y424, into a translational movement of the front valve, along the axis X42.

Here, the technical teaching of U.S. Pat. No. 4,567,924 can be used, which is incorporated into this disclosure by reference. Other systems for transmitting movement between the lever 424 and the front valve 422 are also conceivable.

The body 421 is in turn equipped with two manipulating handles 428, which allow an operator to bring it closer to the port 301 or to move it away therefrom, respectively at the beginning and the end of refueling. The wing fastener 42 is locked on the port 301 and unlocked relative to the latter by rotation about the axis X42, respectively at the beginning and the end of refueling.

In a variant, the two handles 428 are replaced by a wheel.

The elements 32 to 34 together define a fixed flow path for the fuel, between two deformable lines, which in the case at hand are flexible, respectively made by the tubings 20 and 40. This fixed flow path and these deformable lines extend between the connector 21 for connecting on the network R and the wing fastener 42 for connecting on the port 301, within the refueling device 2.

Reference E denotes the flow of fuel between the mouth 200 and the tank 300.

The refueling device 2 is equipped with a meter 50 that makes it possible to measure the quantity of fuel passing through the pipe 34 due to the flow E, that is to say the quantity of fuel delivered to the tank 300 during an operating period of the device 2.

The refueling device 2 also comprises a pressure sensor 52 that makes it possible to measure the pressure of the flow E immediately upstream of the connector 35, for example within the 10 cm before this connector in the direction of the flow E, therefore in particular in the flexible tubing 40.

In a variant, the sensor 52 also makes it possible to measure the flow rate E in the flexible tubing 40.

The refueling device 2 also includes a pressure regulator 60, which makes it possible to monitor the pressure of the flow E in the downstream portion of the pipe 34, therefore in the flexible tubing.

The members 50, 52 and 60 also belong to the refueling device 2.

An electronic unit 110 also belonging to the refueling device 2 is mounted on the chassis of the vehicle 1 and monitors, through suitable electronic signals S50 and S₆₀, respectively the meter 50 and the pressure regulator 60. The meter 50 provides the unit 110 with a signal S′₅₀ representative of the counting that it performs. The pressure sensor 52 in turn provides the unit 110 with a signal S′₅₂ representative of the pressure values P2 that it measures.

The vehicle 1 bears a hydraulic jack 70, the rod 71 of which is equipped with a platform 72 on which an operator stands, who can manipulate the downstream part of the tubing 40, in particular the wing fastener 42. The rod 71 allows the operator, through his upward or downward vertical movement shown by the double arrow Fi, to access the intake port 301.

A module 500, which also belongs to the refueling device 2, is placed around the body 421 of the wing fastener 42. This module 500 assumes the form of two half-shells 500A and 500B that grip the body 421. The module 500 comprises a cell 501 for measuring the pressure of the flow E penetrating the wing fastener 42. The cell 501 is housed in the half-shell 500A.

Given the location of the module 500, which is in the immediate vicinity of the wing fastener 42, the cell 501 makes it possible to determine, with a satisfactory degree of precision, the pressure of the flow E when it enters the tank 300, through the port 301. In other words, the location of the module 500, at the connecting means formed by the wing fastener 42, allows the cell 501 to measure a representative value P1 of the pressure of the flow E passing through the wing fastener 42 when it enters the tank 300. The cell 501 to that end forms a sensor for measuring the value P1 of the pressure P.

In the example, the module 500 is near the front valve 422, such that the distance between the cell 501 and the transfer point of the fuel from the refueling system to the aircraft is less than 10 cm. The transfer point of the fuel is defined at the outlet of the wing fastener 42 as the point where the ownership of the fuel passes from the company supplying the fuel to the company operating the aircraft.

The cell 501 is supplied with electrical energy from a battery 502, housed in the half-shell 500B. Electrical conductors, not shown, extend between the two half-shells 500A and 500B to connect the cell 501 and the battery 502 to one another.

The cell 501 is electrically connected to a radio transmitter 503 also housed in the half-shell 500A and powered by the battery 502. The cell 501 provides the transmitter 503 with an electronic signal S₀(P) corresponding to the value P1 of the pressure that it measures.

The transmitter 503 is equipped with an antenna 504 that allows it to transmit a wireless signal S₁(P) including data corresponding to the value of the pressure P measured by the cell 501. As an example, the transmission mode of the signal S₁(P) is provided by radiofrequency, but in a variant, it can be done by infrared.

Furthermore, the refueling device is equipped with a receiver 600 paired to the module 500 and the antenna 604 of which allows it to receive the signal S₁(P).

The receiver 600 is then able to send the electronic control unit 110 a signal S₂(P) representative of the pressure P of the flow E detected by the cell 501, more specifically the value P1 measured by the cell 501.

The unit 110 can then account for the value of this pressure P in particular in order to control the pressure regulator 60 using the appropriate electronic signal S₆₀.

Reference ΔP denotes the pressure drop of the flow E in the flexible tubing 40.

The unit 110 comprises software means and hardware means, as well as one or several memories, in particular one or several microprocessors including computer programs, as well as one or several memories, allowing it, inter alia, to carry out the steps of the methods mentioned hereinafter automatically.

The unit 110 is configured to calculate a value ΔP1 of the pressure drop ΔP from signals S₂(P) and S′₅₂ received respectively from the cell 501 and the pressure sensor 52.

The measuring frequency of the cell 501 and the sensor 52 can be relatively high, of the order of 50 Hertz (Hz), or even 100 Hz, based on the technology used for these sensors and the technology used for the wireless transmission between the transmitter 503 and the receiver 600. Thus, the unit 110 is able to calculate continuously, at regular intervals, the value ΔP1 of the pressure drop ΔP, during the operation of the refueling device 2.

Furthermore, this calculated pressure drop ΔP1 is compared by the unit 110 with a reference value ΔP0 previously stored in a memory of the unit 110.

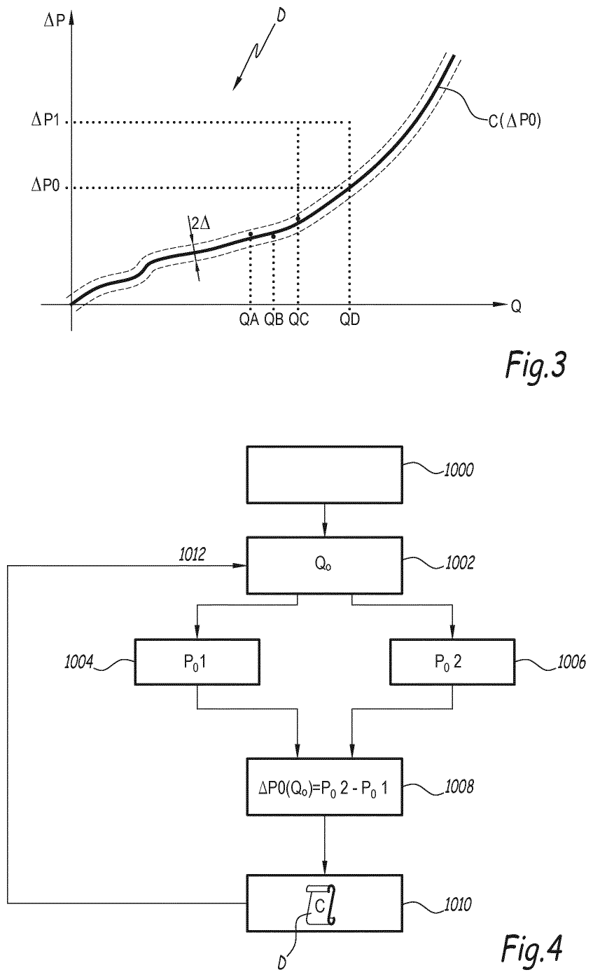

FIG. 3 shows, in solid lines, a curve C showing different reference values ΔP0 of the pressure drop ΔP in the flexible tubing 40, based on the rate Q of the flow E on its path, that is to say in the tubings 20 and 40 as well as in the elements 32 to 34 and 52.

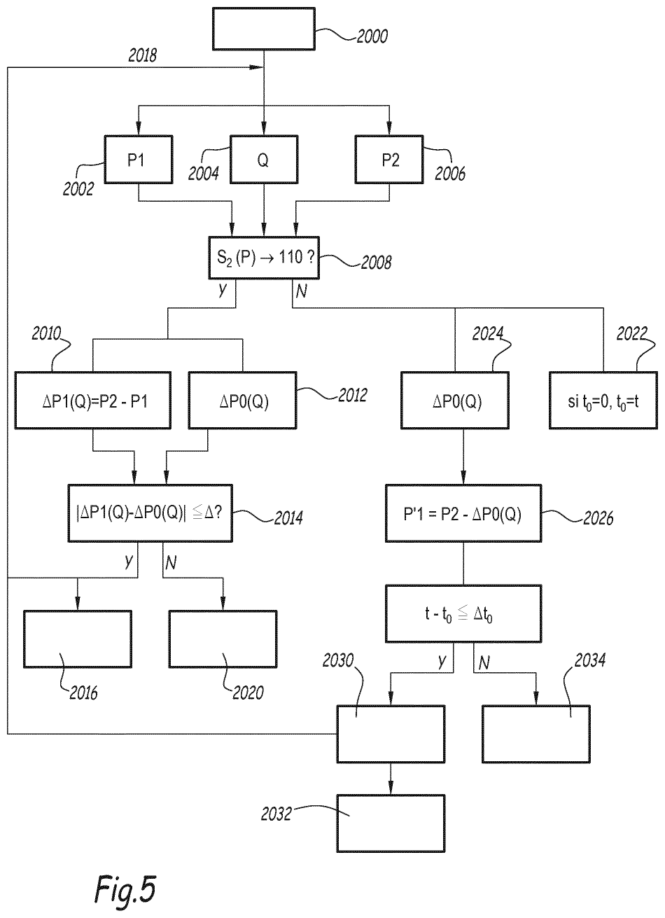

The curve C is established during the commissioning of the refueling device 2, using a method shown schematically in FIG. 4.

This method begins with an initialization step 1000 during which a memory of the unit 110 is reset, then the refueling device 2 is started, such that the flow E is produced from the mouth 200 toward the tank 300, therefore in the flexible tubing 40.

During a step 1002 after the step 1000, the rate Q₀ of the flow E is determined. This determination can take place based on the signal S′₅₀ transmitted by the meter 50 to the unit 110, this signal being derived as a function of time.

The commissioning method according to the invention also comprises two steps 1004 and 1006 during which the pressure of the flow E is measured, respectively by the cell 501 and by the sensor 52, which makes it possible to recover two measured pressure values, namely the value P₀1 measured by the cell 501 in step 1004 and the pressure value P₀2 measured by the sensor 52 in step 1006.

The order of the steps 1002, 1004 and 1006 is not fixed. These steps can be successive, in any order, or simultaneous, as long as they all take place while the flow E is actually happening, with a same rate Q.

After steps 1002, 1004 and 1006, it is possible to determine, for the rate Q₀ in question, the corresponding pressure drop ΔP0(Q₀), which is equal to the difference between the values P₀2 and P₀1. This determination takes place by calculation during a step 1008.

The value ΔP0(Q₀) calculated in step 1008 is stored in the memory of the unit 110, as part of a data set D representing the curve C of FIG. 3, which takes place in a step 1010.

Steps 1002 and 1010 are repeated for different values of the rate Q₀, which represents the arrow of iteration 1012 in FIG. 4.

Thus, the method of FIG. 4 makes it possible to create a data set D that contains, for different values of the rate Q₀, the associated pressure drop values ΔP₀ that have been measured during the commissioning of the refueling device.

The curve C can then be created by interpolation between the measured values.

Since the commissioning takes place with functional equipment, whether because it is new equipment or because the commissioning takes place after a maintenance operation, it is possible to consider that the curve C is representative of the pressure drop ΔP in the normal usage configuration of the refueling device 2. The curve C is therefore a reference value curve ΔP0 for the pressure drop ΔP in the flexible pipe 40.

During the use of the refueling device 2 after commissioning thereof, a refueling method is implemented that is partially shown in FIG. 5. FIG. 5 is a block diagram of the refueling method of the invention, where only the steps relevant for the present invention are shown.

The refueling method of the invention comprises an initialization step 2000, during which memories of the unit 110 affected by the refueling method are reset, but not those containing the data set D. In particular, the value to used later in step 2022 is set to zero.

After step 2000, three steps are implemented, in any order, namely steps 2002, 2004 and 2006. During step 2002, the value P1 of the pressure P of the flow E in the flexible pipe 40, in the vicinity of the wing fastener 42, is measured by the cell 501. During step 2004, the value of the rate Q of the flow E is calculated by the unit 110, based on the signal S′₅₀. During step 2006, the value P2 of the pressure P upstream of the pipe 40 is measured by the sensor 52.

During a step 2008, the unit 110 verifies whether it has indeed received the signal S′₂(P) representative of the value P1 measured by the cell 501.

If this is the case, the unit 110 implements a step 2010 where it calculates the value ΔP1 of the pressure drop, by subtracting the value P1 obtained in step 2002 from the value P2 obtained in step 2006. This value ΔP1 is valid for the rate Q determined in step 2004.

In parallel, before or after step 2010, the unit 110 implements another step 2012 during which it determines, for the same rate Q, the reference value ΔP0 that belongs to the curve C, by accessing the memory of the unit 110 where the data set D was stored during step 1010.

During a subsequent step 2014, the absolute value and the difference between the values ΔP1(Q) and ΔP0(Q), respectively calculated and obtained in steps 2010 and 2012, is in turn calculated and compared to a preestablished allowance margin Δ.

In practice, the allowance margin Δ is chosen by the manufacturer or the user of the refueling device 2. It can be expressed in the form of an absolute value, for example 0.2 bars or 0.5 bars, or in the form of a percentage of the average pressure drop observed in the flexible tubing 40 of refueling devices of the same type as the device 2, for example 2% of this average pressure drop.

In other words, returning to FIG. 3, a “tube” is defined around the curve C having a width 2Δ that corresponds to pressure drop values for which the refueling is considered to take place normally.

This is shown by the values associated with the rates Q_{A}, Q_{B} and Q_{C} in FIG. 3. In this case, a signal can be transmitted by the unit 110 during a step 2016 in order to confirm that the refueling is taking place normally. Furthermore, as shown by the iteration arrow 2018, steps 2002 to 2014 are implemented again, periodically at a predetermined frequency, for example 10 to 20 Hz. Thus, the measuring steps 2002, 2004 and 2006 and the following calculation steps can be considered to be done continuously.

Otherwise, when the comparison of step 2014 shows that the deviation between the values ΔP1(Q) and ΔP0(Q) is strictly greater than the allowance margin Δ, as shown for the rate Q_{D} in FIG. 3, the unit 110 transmits a signal as a warning that the refueling is occurring abnormally, due to the pressure drop detected in the flexible tubing 40, which takes place during a step 2020.

Depending on the case, it may be provided that, after step 2020, the refueling method is stopped or continued with a decreased pressure setpoint of the regulator.

Thus, steps 2000 to 2020 of the refueling method of FIG. 5 make it possible to ensure monitoring of the pressure drop in the flexible tubing 40.

In case of partial obstruction of the flexible tubing 40 or clogging of a filtering sieve placed at the inlet of the wing fastener 42, the pressure drop ΔP in the tubing 40 increases substantially, to the point that the result of the comparison of step 2014 is negative, that is to say outside the allowance, which can be reported to a user during step 2020.

Likewise, at a given rate, the value measured by the sensor 501 must be equal to the value measured by the sensor 52 decreased by the pressure drops. In other words, the system has a feature for auto-monitoring of the data by the pressure sensors 501 and 52. This property can be taken into account by the electronic unit 110 in order to modify the operating conditions of the pressure regulator 60 using the signal S₆₀.

Under these conditions, in light of the safety benefits provided by the redundancy of these measures, the continuous monitoring of the actual values of the pressures and the traceability of these values, there is cause to wonder about the usefulness of a mechanical regulator incorporated [into] the fastener 42 in the known equipment, this regulator being positioned downstream of the flexible tubing 40. While being sure to respect the operating safety of the refueling device 2, it can be considered to work, in the refueling device 2 of the invention, with no mechanical pressure regulator placed on the flow path E, at the outlet or downstream of the flexible tubing 40. This causes a noticeable increase in the weight of the assembly formed by the tubing 40 and the wing fastener 42, as well as a simplification of its production and maintenance and improved safety, in particular in terms of traceability of the operations.

Owing to the refueling method described above, it is possible to account for the value P1 of the pressure P of the flow E measured in the vicinity of the transfer point A in order to regulate, owing to the unit 110 and the signal S₆₀, the pressure of the flow E upstream of the flexible tubing 40. The refueling therefore does not incorporate a mechanical pressure regulator arranged, on the flow path E, at the outlet of or downstream of the flexible tubing 40, unlike the known devices. This feature is, however, optional. For redundancy or normative reasons, a mechanical regulator can, in a variant that is not shown, be arranged on the path of the flow E, at the outlet of or downstream of the flexible tubing 40.

It emerges from the preceding that the cell 501 and the electronic unit 110 make it possible to control the pressure regulator 60 with the signal S₆₀ based on the value P1 of the pressure P measured by the cell 501. The parts 501 and 110 thus form a control loop of the pressure regulator 60, which makes it possible to adjust the pressure P of the flow E near the wing fastener 40.

According to one particularly advantageous aspect of the invention, which is optional and shown by steps 2024 to 2034 in FIG. 5, the refueling method of the invention can also make it possible to treat a temporary interruption in the transmission of the pressure values between the transmitter 503 and the receiver 600. Indeed, in light of the latency of the wireless transmission used, between the elements 503 and 600, this transmission may be disrupted or delayed, to the point that the unit 110 does not have, in the desired time, the value P1 measured by the cell 501 in order to effectively control the different parts of the refueling device, including the pressure regulator 60.

It should be noted that the transmission of the signals S′₅₀ and S′₅₂ to the unit 110 is not subject to disruptions, since the transmission of the signals S′₅₀ and S′₅₂ is wired. It can in particular take place using shielded cables.

In the case where the reception of the signal S₂(P) by the receiver 600 is temporarily interrupted, it may be hypothesized that the variation of the pressure drop ΔP in the flexible tubing 40 is relatively slow, to the point that this pressure drop can be considered constant over a relatively short time period, for example equal to 500 ms.

If the result of the verification of step 2008 is negative, that is to say the unit 110 does not have the signal S₂(P), the unit 110 implements a step 2022 where it substitutes the value to by making it equal to that of the instant t where the transmission defect of the signal S₂(P) was observed.

A step 2024 is then implemented for accessing all of the data D representing the curve C in order to determine the pressure drop ΔP₀(Q) in the flexible tubing 40 for the rate Q measured in step 2004.

A subsequent step 2026 is then implemented during which a substitution value P′1 for the value P1 measured by the cell 501 in step 2002 is calculated, as the difference between the value P2 measured by the second sensor 52 in step 2006 and the value of the pressure drop ΔP0(Q) determined in step 2024.

During a subsequent step 2028, the unit 110 calculates the duration between the current instant t for calculation of the value P′1 in step 2026 and the instant to determined in step 2022. If this difference is less than a configurable value Δt₀, this means that the data transmission has been interrupted during less than the value Δt₀. In this case, the control of the refueling process can have taken place in a downgraded manner in step 2030 and steps 2002 and following of the refueling method can have been implemented iteratively, which is shown by arrow 2018.

In practice, the configurable value to can be chosen between 50 and 200 ms.

Also in this case, the unit 110 can implement an optional step 2032 indicating that the value of the pressure of the flow E in the vicinity of the wing fastener 42 is an estimated value P′₁ and not a measured value P1 and that the refueling device is operating in downgraded mode.

In the case where the verification of step 2018 yields a negative result or a result outside the allowance, that is to say in the case where the transmission defect of the signal S₂(P) has taken place over a period greater than the maximum duration Δt₀, a step 2034 is emitted during which an alarm signal is transmitted by the unit 110.

In the preceding, the tubing 40 is a flexible tubing. In a variant that is not shown, it may be a polyarticulated tubing made up of several rigid segments connected to one another by rotary joints.

In a variant of the invention that is not shown, in place of a rate Q calculated based on the signal S′₅₀ from the meter 50, it is possible to use a rate measured by a flow meter arranged on the pipe 34, preferably upstream of the connector 35. As mentioned above, this flow meter can be integrated into the pressure sensor 52.

The invention is shown in the case where the elements 501 to 503 are arranged in a module 500 formed by two half-shells 500A and 500B. However, this is optional and other methods of assembling the measuring cell 501 on the fastener 42 are conceivable, in particular that described in WO-A-2010/128246.

The invention is described above in the case where the electronic unit 110 is used at once to calculate the pressure drop ΔP1, to compare this pressure drop with the reference value ΔP0 and to calculate the substitution value P′1. Depending on the case, a same microprocessor of the electronic unit 110 can be used for the aforementioned calculations and comparison or different computers separate from this unit 110 can be used. In a variant, several separate electronic units can be provided to that end.

The invention is described above in the case where the refueling device 2 is mounted on the vehicle 1 and connected to a fuel supply network. However, it is applicable to the case where this device is mounted in a fixed station. It is also applicable to the case where the vehicle 1 is a bowser equipped with a fuel tank and a pump.

The features of the embodiments and variants considered above may be combined with one another to generate new embodiments of the invention.

1. An aircraft refueling device comprising:
a deformable pipe for circulation of fuel, the downstream end of which is provided with a wing fastener for connection thereof onto an intake port of an aircraft fuel tank;
a first sensor for measuring pressure values in the vicinity of said wing fastener, of a fuel flow in said deformable pipe;
a member for determining the rate of the flow in said deformable pipe;
a second sensor for measuring pressure values of the flow upstream of said deformable pipe;
a calculating unit for calculating a value of the pressure drop of the flow in said deformable pipe, based on the pressure values measured by said first and second sensors; and
a comparison unit for comparing the calculated pressure drop value with a reference value established for the same flow rate.

2. The refueling device according to claim 1, further comprising:
a pressure regulator installed on the path of the flow, upstream of said deformable pipe; and
a control loop of said pressure regulator comprising said first sensor, said calculating unit, and said comparison unit.

3. The refueling device according to claim 2, wherein the refueling device has no mechanical pressure regulator arranged, on the flow path, at the outlet of or downstream of said deformable pipe.

4. The refueling device according to claim 1, further comprising means for calculating a value of the pressure in the vicinity of said wing fastener, of the fuel flow in said deformable pipe, based on the pressure of the flow upstream of said deformable pipe, and on the reference value established for the same flow rate.

5. A method for commissioning a refueling device according to claim 1, the method comprising:
establishing a relationship between the fuel flow rate in the deformable pipe and the pressure drop in the deformable pipe, in the normal operating condition of the refueling device; and
storing, for different flow rates, a reference value of the pressure drop in the deformable pipe.

6. A method for refueling an aircraft using an aircraft refueling device according to claim 1, commissioned by a method for commissioning that comprises establishing a relationship between the fuel flow rate in the deformable pipe and the pressure drop in the deformable pipe, in the normal operating condition of the refueling device, and storing, for different flow rates, a reference value of the pressure drop in the deformable pipe, the method for refueling comprising:
measuring a first value of the pressure of the fuel flow in the deformable pipe in the vicinity of the wing fastener, using the first sensor;
determining the flow rate in the deformable pipe;
further measuring a second value of the pressure upstream of the deformable pipe, using the second sensor;
calculating the value of the pressure drop in the deformable pipe, by subtracting the value measured by said measuring from the value measured in by sad further measuring; and
g) comparing the value calculated by said calculating to the reference value stored by the storing, for the same rate as that determined by said determining.

7. The method for refueling according to claim 6, further comprising:
based on the result of said comparing, and on a preestablished tolerance margin, indicating that the refueling is taking place normally or abnormally.

8. The method according to claim 6, further comprising transmitting pressure values measured by the first sensor to a control unit of the refueling device, wherein, in case of temporary interruption of said transmitting, the method for refueling further comprises:
accessing the reference value of the pressure drop stored by the storing, for the same rate as that determined by said determining;
further calculating a substitution value for the value measured by the first pressure sensor by subtracting the reference value accessed by said accessing from the second value measured by said further measuring; and
using the substitution value calculated by said further calculating, in place of the value measured by the first sensor, to monitor the refueling in progress, without interrupting the refueling.

9. The method for refueling according to claim 8, wherein, in case of temporary interruption of said transmitting, the method for refueling further comprises indicating that the refueling is taking place in a temporarily downgraded mode.

10. The method according to claim 8, wherein said determining, said further measuring, said accessing, said further calculating, and said using are implemented by iteration during a time interval with a predetermined maximum duration, and wherein, in case of persistence of the temporary interruption of said transmitting beyond the predetermined maximum duration, the method for refueling further comprises emitting an alarm signal.
